(19) United States
(12) Patent Application Publication
(10) Pub. No.: US 2009/0042156 A1
(43) Pub. Date: Feb. 12, 2009

(54) Device for protecting metallic surfaces from high-temperature condensates of corrosive media in technical installations

(76) Inventors: Michael Meckelnburg, Reinbek (DE); Rene Gross, Neunkirchen (DE); Kurt Weber, Herchweiler-Pettersheim (DE)

Correspondence Address: PAUL, HASTINGS, JANOFSKY & WALKER LLP, 875 15th Street, NW, Washington, DC, 20005, US

(21) Appl. No.: 11/660,503

(22) PCT Filed: Jul. 26, 2005
(86) PCT No.: PCT/DE05/01311

§ 371 Date: Mar. 7, 2008

(30) Foreign Application Priority Data
Aug. 21, 2004 (DE) 10 2004 040 625.1

(51) Int. Cl. F27D 1/00

(52) U.S. Cl. 432/247

(57) ABSTRACT

The supporting structure of a technical installation made from a material that is not resistant to corrosion and whose inner wall at least temporarily contains a corrosive and abrasive gas-vapor mixture and is protected from acid corrosion by a gas-vapor mixture barrier. This barrier is either placed between a refractory coating (6) and a thermal insulating layer (7) or is integrated into the refractory layer (6) or in the thermal insulating layer (7). The mechanical protection from the permeation of the gas-vapor mixture though the thermal insulation (7) up to the inner wall of the supporting structure allows a thermal insulating material to be selected that has a distinctly reduced thermal conductivity and thus allows the temperature on the exterior of the supporting structure to be lowered reducing energy consumption and improving occupational safety.

### BACKGROUND

1. Field of the Invention

The invention relates to technical installations such as blast furnace stoves comprising hot blast pipes and hot blast valves on which high-temperature condensates of gaseous corrosive media form which cause damage to the metallic walls of the technical installations. The invention particularly relates to a barrier device for high-temperature gaseous media used as a barrier for hot gas pipes that lead from a blast furnace stove to a blast furnace and which comprises a housing fitted with seal seats that are cooled by a cooling medium and a barrier element that is movable inside the housing and that is cooled by a cooling media whereby all surfaces that come into contact with the hot gas with the exception of the housing valve seals and the sealing surfaces on the barrier device are coated with a refractory coating.

2. Background of the Invention

DE 41 38 283 C1 discloses that all surfaces of a barrier device that are not cooled and that come into contact with hot gas are provided with an auxiliary highly thermal insulating material between the refractory coating and the metal structure to virtually eliminate wear caused by acid corrosion.

Acid corrosion on the interior walls of the steel sheet cladding is caused by corrosive liquid that forms from condensation of humid air and that contains gaseous pollutants from the areas of the blast furnace stove, the hot blast pipes and the hot blast valves it has flowed through. In addition to these chemical causes there are also thermal influences related to high temperatures and temperature fluctuations which cause or accelerate corrosion. The causes of this are, for example,
Oxidation of molecular nitrogen from the air to nitrogen oxides NOx;
increased reaction velocity of the chemical corrosion process;
increased molecular transport of reactants and of reaction products resulting from diffusion;
deterioration of passive layers and reduction of the mechanical strain resistance;
formation of condensates of corrosive liquids below and above the dew point temperature.

Water vapor is always present inside blast furnace stoves, hot blast pipes and hot blast valves. During the heating process, water vapor mainly results from the combustion products while during the hot blast process it results from the humid air. Water vapor penetrates grooves and microscopic fissures in the refractory lining such as refractory concrete but it also penetrates microscopic channels in porous refractory stone and auxiliary insulation made from mineral fibers boards or refractory linings on the interior wall of the steel sheet cladding. If the temperature of the steel sheet cladding is lower than the dew point temperature, polluted condensates of liquid water will form. The condensate which contains pollutants causes corrosion and thus damage to the steel sheet cladding. Prior art discloses methods for avoiding corrosion by employing, for example, exterior and interior insulation, double cladding renewal, use of highly alloyed steels and by lowering the dome temperature. Furthermore, using low alloyed steel 16Mo3 for the steel sheet cladding of the blast furnace stove is also recommended. However, past experience clearly shows that damage reliably can be prevented both by employing an exterior insulation and highly alloyed steel. Interior insulation has thus far also shown good results.

Exterior and interior insulation aid in keeping the steel sheet cladding temperature above the dew point temperature and in this manner prevent the formation of condensates and thus corrosive liquids. However, the dew point temperature depends on the gaseous atmosphere on the interior of the blast furnace stove which thermodynamically is called binary gas mixture, namely in the form of a gas-vapor mixture both during the heating and the hot blast process. In the temperature range relevant in this context the state of a gas is always so far removed from its wet steam state that it is always thermodynamically treated as gas. The other gas component is close to its two-phase state so it can condense. This gas is a “vapor.”

A common example for gas-vapor mixtures is the humid air, a mixture of dry air and water vapor. Isobaric cooling leaves the vapor content of the still unsaturated humid air constant while relative humidity increases. This process continues until saturation is achieved. The temperature associated with this is called the dew point temperature.

Condensation occurs as the temperature dips below the dew point temperature, liquid water is separated as condensate and the vapor content is reduced. As the temperature is further lowered this process follows a curve which is called the saturation curve until the temperature reaches a point at which condensation ceases. If the air pressure rises during this process, the saturation curve will shift upwards. This means that the dew point temperature not only depends on the water vapor content but also on the pressure. In this particular example the dew point temperature would rise.

The following example will illustrate the fluctuations: With 20% by volume water vapor concentration and a pressure of 1 bar the dew point temperature lies at approximately 60° C., at a pressure of 5 bar the dew point temperature rises to approximately 100° C. During the blast furnace heating process, the pressure changes during each phase which also affects the hot blast valves and the hot blast pipes. Different dew point temperature levels are thus always established. The water vapor concentration also fluctuates because air insufflation takes air from the normal (ambient) atmosphere and humidity fluctuates daily or with each season. An additional parameter that influences the dew point temperature is the chemical composition of the gaseous atmosphere inside the blast furnace stove. When the gas atmosphere, in addition to water vapor, comprises various acid vapors such as nitric acid HNO₃, sulfuric acid H₂SO₄ or hydrochloric acid HCl, the dew point temperature fluctuates. At the same pressure at a water vapor content of 10% as well as an additional nitric acid content of 10³ ppm the dew point temperature changes from 45° C. to 55° C. If there is an equal content of sulfuric acid instead of nitric acid vapor, the dew point temperature rises from 45° C. to 185° C. The structural design of blast furnace stoves, hot blast pipes and hot blast valves can prevent the condensation of corrosive liquids if the interior surfaces of the steel casings remain so warm that it never falls below the dew point temperature. The ambient air temperature plays an important role for interior insulation. It can fluctuate considerably according to where in the world the blast furnace stove is located. In Canada temperatures rise above 30° C. during the summer but in deep winter temperatures fall considerably below the minus point to between −20° C. and −40° C.

Assuming the outside temperature is 45° C. and the hot blast temperature is 1150° C. at the first insulation layer that is made from refractory concrete which is commonly used for hot blast valves as well as at a highly thermal insulating auxiliary insulation material placed between the refractory concrete and the steel sheet cladding, the temperature on the interior of the steel cladding will reach approximately 185° C. This temperature approximately corresponds to the dew point temperature of sulfuric acid as has been described above. If the temperature of the steel sheet cladding changes as the outside temperature falls to, for example, −20° C. which is lower than the dew point temperature undesired corrosive liquids form from condensation on the interior of the steel sheet cladding.

The extent to which the temperature falls below the dew point temperature has significant influence on the composition of the condensate and on the corrosion behavior. If the temperature falls only slightly below the dew point temperature the pH values are lower. For pH values below 3 it is well-known that no inter-granular fissure corrosion is caused on low alloyed steel but rather surface corrosion also known as trough corrosion appears.

For the structure of blast furnace stoves, hot blast pipes and hot blast valves the design of the steel sheet cladding plays an important role since the outside temperature influences the dew point temperature in particular on the interior insulation. If the temperature on the interior surface of the steel sheet cladding is maintained at a level significantly above the dew point temperature, temperature related humidity and tensile strain problems arise. The expansion and shrinking movements caused by tensile strains which inherently occur during the heating and blast phases of the hot blast process result in alternating strain with a load change frequency ranging from between 5000 and 8000 per year and damage caused to the most brittle protecting layers of the cladding sheets and to the blast furnace stove, hot blast pipe and hot blast valve.

A number of measures are taken to protect the blast furnace stove against the formation of condensates. However, during the hot blast phase the damaging gases are blown into the hot blast pipe, the hot blast valve and the blast furnace pipe where condensation could then form. The condensation problem is thus simply moved to another location.

In addition to the appearance of corrosion below the dew point temperature threshold, chemical reactions that cause corrosion also occur above the dew point threshold.

Ammonium nitrate NH₄NO₃, a saturated aqueous corrosion liquid, causes damage to the steel sheet cladding. To a certain extent it forms above the dew point temperature.

The presence of nitrogen oxides NOx during the various blast furnace stove phases cause the formation of the corrosion-causing ammonium nitrate. It is well-known that the NOx concentration rises as the temperature rises. Non-temperature related causes also play a role in the formation of nitrogen oxides: For example, NO forms during the heating phase from the fuel used. The blast furnace fuel contains HCN and NH₃ which form NO during combustion. However, during the change-over, waiting and blast phases NO is formed from N₂ and thermal O₂. Convective substance transport during the change-over phase has considerable influence on the NO concentration. Particularly noteworthy, is the high NO concentration during the filling phase. The convective substance transport associated therewith allows the gas with the high NO concentration to reach from the interior space to the steel cladding. It is thus the object of the present invention to prevent corrosion caused by nitrogen oxides.

The attempts to lower the nitrogen oxide content by, for example,
lowering the O₂ concentration by turning off the burner,
eliminating the waiting phase for the blast furnace stove process,
reducing the time necessary to reset the controls during the change-over phase,
reducing the filling time,
reducing free burner volume,
   have not had the desired results since nitrogen oxide transformation predominantly occurs while the blast furnace stove is being filled. The low temperatures prevailing during filling allows the nitrogen oxide to reach the steel sheet cladding of the blast furnace stove and the hot blast valve. This is where the transformation to NO₂ occurs. The result of the above described measures merely is a reduction of the amount of NO₂ formed but not the prevention of its formation.

In addition to nitrate ions the condensates in the blast furnace stove also contain ammonium ions. However, the gaseous atmosphere of the blast furnace stove does not contain ammonia which is why experts in the field assume that the ammonium ions present in the condensates only could have resulted from the nitrate ions. The cause of this is the corrosion attack of the nitric acid from the steel. A deposit of iron corrosion product forms on the steel sheet cladding. By way of a chemical redox reaction the corroding iron reduces part of the nitrate to ammonia. Ammonium nitrate salt forms from the surplus nitric acid and has long been known to cause tension fissure corrosion in the fertilizer industry. It can thus be assumed that the formation of the corrosion deposit containing ammonium nitrate on the blast furnace stoves, hot blast pipes and hot blast valves also is responsible for the tension fissure corrosion.

When observing the dew point temperature on the steel sheet claddings of blast furnace stoves, hot blast pipes and hot blast valves it can be concluded that corrosion-causing chemical compounds form both below and above the dew point temperature. To further complicate the corrosion prevention efforts the concentrations of harmful chemical substances present in the gaseous atmosphere also react amongst each other, which causes various types of corrosion.

When the humid gaseous atmosphere contains both nitrogen oxides NO₂ and sulfur oxides SO₂, a condensate of sulfuric acid H₂SO₄ and nitric acid HNO₃ will form as it cools. With adequate H₂SO₄ concentration HNO₃ will be almost completely reduced to NH₃. By neutralizing H₂SO₄, ammonium sulfates (NH₄)₂SO₄, or as the case may be, NH₄HSO₄ are formed. However, if the gaseous atmosphere does not contain SO₂, the condensate formed will only contain HNO₃. Under these circumstances, ammonium nitrate NH₄NO₃ is formed. This corresponds to a 50% conversion rate to NH₃ but a 100% neutralization rate of HNO₃. The SO₂ in the gaseous atmosphere must therefore be a protecting factor against the tension crack fissure corrosion causing ammonium nitrate since it prevents its formation by reducing nitrate ions. However, the presence of SO₂ causes the above-described corrosion.

Industrial measures intended to reduce tension fissure corrosion by reducing NO formation especially during the filling step are well-known. The above-described changes in the operation methods of a blast furnace stove have a direct effect on the reappearance of NH₄NO₃. However, if NH₄NO₃ has already formed on the steel sheet cladding surface due to the operational method, the tension fissure corrosion cannot be reliably eliminated even if employing a blast furnace stove operational method without NO formation. In that situation, only secondary measures such as exterior insulation can offer effective protection. Interior insulation does not offer effective protection due to its gas permeability characteristics. Even if the steel sheet cladding is kept above the dew point temperature for a short period of time, the fluctuating exterior ambient temperatures can cause the temperature to fall below the dew point temperature. As has already been explained, the steel sheet cladding temperature must be kept at approximately 195° C. if the gaseous mixture contains SO₂. This not only requires high energy consumption but also causes considerable thermal induced tensile stress in the steel sheet cladding structure. At temperatures above 120° C., tensile strength of the steel is considerably reduced and the passive layer which is supposed to protect against corrosion is destroyed. In the interests of accident prevention it is not acceptable to employ steel sheet cladding temperatures above 195° C. since such temperatures would pose a danger to the device operators. Cost considerations prevent the use of corrosion resistant, highly alloyed steels for the steel structure.

Already employed highly thermally resistant interior insulations are made from mineral fiber boards do not sufficiently protect against dew point corrosion because the steel sheet cladding temperature must be permanently kept at approximately 195° C. which, however, is not possible due to the exterior temperature fluctuations.

In the barrier device disclosed in DE 41 38 283 C1, a highly thermal insulating auxiliary insulation material which is fitted between the refractory layer and the metal structure is not gas pressure tight so harmful gases can reach the steel sheet cladding structure. The solution described is primarily concerned with both keeping the steel sheet cladding structure sufficiently warm by insulating it with exterior and interior insulation to prevent the temperature from falling below the dew point which would cause corrosion and to preventing high energy consumption.

Securing the thermal insulation material on common hot blast valves is achieved using, for example, expansion ties made from metal which are fastened to the steel sheet cladding structure using stud welding devices. The metallic expansion ties hold the thermal insulation material and the entire system is held together by sealing the refractory cladding in concrete. The disadvantage of this metallic solution is that the expansion ties conduct the heat to the steel sheet cladding. Prior art discloses anchoring that comprises headless screws onto which a ceramic cap is fitted to achieve a certain thermal insulation effect. However, a refractory concrete layer will not adhere to this ceramic cap.

Prior art discloses water pipes for the cooling agent inflow and outflow that are not insulated even though they come into contact with the warm gas-vapor mixtures when the valve is closed. When the hot blast valve is open, the impermeable surfaces and handling surfaces of the hot blast valve disc and the impermeable surfaces lining the housing that come into contact with the gas-vapor mixture are not insulated either in prior art. In the closed position, the handling surfaces of the hot blast valve disc and a housing seal seat and the seal seat of the hot blast valve disc located opposite the barrier side come into contact with the hot gas. Today, corrosion problems on the non-insulated housing seal seats and the hot blast valve disc as well as on the exterior circumference of the hot blast valve disc and on the water pipes are solved by using materials such as higher alloyed steel with correspondingly better corrosion resistance. Energy consumption reducing measures do not yet exist.

DE 1 955 063 discloses a barrier device for high-temperature gaseous media with the characteristics claimed in the preamble of claim 1. It is in particular disclosed that the interior structure consists of a refractory lining behind which the insulation is fitted.

### BRIEF SUMMARY OF THE INVENTION

It is an object of the present invention to further improve a subject specific technical installation in such a way that acid and tensile fissure corrosion on the steel sheet cladding is prevented as much as possible. It is another object of the present invention to provide a securing system for the multi-layered insulation system that comprises at least one refractory layer and one layer made from thermal insulation material which to a large extent prevents thermal conductivity to the steel sheet cladding. It is furthermore an object of the present invention to disclose steps for a subject specific installation that will reduce energy consumption.

The object of the present invention is solved with a barrier device in accordance with claim 1. The gas-vapor mixture barrier fitted on the interior of the support structure, in other words, on the interior wall of the steel sheet cladding surface, prevents the harmful gas-vapor mixtures from coming into contact with the steel sheet cladding structure. The multi-layered interior insulation system comprises at least one refractory coating on a layer made from thermal insulation material whereby the refractory coating is aligned with the interior space of the support structure.

The invention is suitable for use in technical installations from the group comprising hot blast valves, blast furnace stoves, blast furnace pipes or exhaust pipes in power plants on which a corrosive condensate forms as a result of changes to the chemical composition as the ambient air is heated as described above.

The invention particularly discloses a barrier device for high-temperature gaseous media, in particular, for use as a barrier for the hot gas pipes that lead from blast furnace stoves to a blast furnace whereby the barrier device comprises a support structure with a moveable barrier element fitted in a housing that is cooled by a cooling medium whereby the surfaces that come into contact with the hot gas partially are coated with a refractory coating and a gas-vapor mixture barrier is fitted on the interior of the support structure.

Recent analysis of the thermal distribution inside such devices from the passage way via the shaft to the hood has shown that, depending on the temperature, it is not necessary to coat some sections of the device with a refractory coating consisting of refractory or lightweight refractory concrete. In those sections it suffices to use fire resistant materials. In other areas, materials that are resistant up to temperatures of 600° C. can be used.

In those sections, materials that result from the new technology described here and that have a finely porous xonolite structure with crystals that are finely porous insulating material and matrix stabilizer pyrogenic silicic acid are used. Such materials distinguish themselves by their homogeneity, strength and good workability. Furthermore, the thermal conductivity of these materials is significantly lower than, for example, that of refractory or lightweight refractory concrete. While previously, thermal insulators were employed as exterior insulation, the new materials can be used directly inside the furnace. For example, thermally insulating boards with a vermiculite coating are used.

Experts follow guideline DIN 51060, June 2000: This guideline includes DIN-EN 993, March 1997, which dictates that “refractory” means withstanding temperatures of between 1500-1800° C.

In everyday language “refractory” means materials that can withstand high temperatures (between 600 to 2000° C.). When sections within the device are described here as not requiring a refractory coating made from refractory or lightweight refractory concrete, the applicable temperature range is lower than 600° C., which conforms to everyday language.

The thermally insulating boards comprising a vermiculite coating are classified to temperatures of 1000° C. and are thus “refractory” as defined by everyday language but not as defined by the expert who defines the word as meaning a temperature of 1500° C.

The advantage of the present invention is that when using a gas-vapor barrier the thermal insulation effect is increased and the consumption of energy falls since the steel sheet cladding temperature can be lowered to correspond with or be lower than the ambient air temperature as it no longer is relevant if the temperature falls below the dew point temperature on the interior.

In accordance with a further embodiment of the present invention the gas-vapor mixture barrier can alternatively be executed by
(a) fitting it between the refractory lining made from, for example, refractory concrete, lightweight refractory concrete or refractory stones, thermally insulating boards with a vermiculite surface and the thermal insulation,
(b) integrating it into the refractory lining in a multi-layered structure, or
(c) integrating it within the thermal insulation in a multi-layered structure.

The advantage of variant (a) is that when the gas-vapor mixture barrier is fitted between the refractory lining and the thermal insulation it can be done in such a way that no water reaches the thermal insulation which means that it does not necessarily have to be made from water repellent materials. Water repellent materials are used in the manufacturing of thermal insulation due to the processing of the refractory lining. Water is used when processing refractory concrete or lightweight refractory concrete and this water reaches the material used for the thermal insulation.

The higher the temperature resistance of the gas-vapor mixture barrier is the closer it can get to the high-temperature gaseous corrosive media and it can thus be integrated into the refractory lining (variant (b)). Depending on the material used for the gas-vapor mixture barrier, metallic or non-metallic, other parameters must be considered such as thermal expansion behavior and the corrosion behavior of the gas-vapor mixture barrier itself.

In accordance with variant (c) the gas-vapor mixture barrier is integrated within the thermal insulation, which is a multi-layered structure. In this variant the temperature resistance demands are lower.

In accordance with another embodiment of the present invention a material is used for the thermal insulation that shows far less thermal conductivity than the mineral fiber boards disclosed in patent number DE 41 38 283 C1, namely powder filament mixtures pressed into solid panels, blocks or glass fabric. The thermal conductivity is four to five times lower than that of mineral fiber boards. By reducing the thickness of the thermal insulation it is structurally possible to add a gas-vapor mixture barrier and still construct the housing of the barrier device using the usual dimensions.

In accordance with a preferred embodiment of the present invention it is possible to reduce the thermal conductivity to less than about 0.016 W/m-K, and preferably to less than about 0.01 W/m-K, by employing vacuum evacuated pressed powder filament for a temperature range of between 100° C. and 500° C. In this manner, the thickness of the thermal insulation layers can be considerably reduced and the support structure will require less interior space. In this manner, the support structures are cheaper. The thermal insulation material is further protected from humidity and water by the vacuum lining. Water repellent powder filaments that are not protected by a vacuum lining must be additionally treated by the manufacturer to acquire water repellent characteristics. These pressed powder filaments are more expensive and have higher thermal conductivity and thus are less thermal insulating. If vacuum covered powder filament is not used, the gas-vapor mixture barrier assumes the protection against humidity and water, which doubles the thermal conductivity. The scope of thermal insulation is adjusted to correspond to temperature distribution in the interior of the support structure.

In accordance with a further embodiment of the present invention the gas-vapor mixture barrier of the barrier device alternatively comprises
(d) a metal;
(e) a non-metal; or
(f) a vacuum sleeve.

In accordance with variant (d) the gas-vapor mixture barrier is metallic. The high-temperature corrosion behavior must therefore also be considered since when using a metallic embodiment a minimum temperature that is above the dew point temperature of the employed gas-vapor mixture must be maintained which for a blast furnace stove lies at approximately 200° C. In this embodiment the gas-vapor mixture barrier can also be integrated into the thermal insulation or between the refractory lining and the thermal insulation.

In accordance with variant (e) the gas-vapor mixture barrier is non-metallic so it cannot be attacked by corrosion. However, condensates that may have developed would have to be removed so it is preferable to maintain a temperature not below 200° C. in a hot blast valve.

In accordance with variant (f) the gas-vapor mixture barrier is a vacuum sleeve of a vacuum evacuated thermal insulation made from a powder filament material. Variant (f) reduces costs as the material used for the thermal insulation does not have to be water repellant.

The individual materials used for the components for the thermal insulation, gas-vapor mixture barrier and refractory coating mutually interact and their individual thermal expansions must be adjusted to each other in such a way that the components can move without being damaged.

The securing system for a multi-layer interior insulation system which comprises at least one refractory coating and one thermal insulating layer is fitted on the interior of a support structure which is made from a material that is not resistant to corrosion, and, in accordance with the invention, said securing system comprises ceramic expansion ties which are screwed into a metallic securing pin or are fastened to a bayonet pin and are fastened to the steel sheet cladding structure with said securing pin or bayonet pin and which carry the material for the thermal insulation with the side that is opposite the steel sheet cladding structure, whereby the legs of the expansion ties are made from the material used for the thermal insulation and the remaining section of the legs is designed to secure the refractory coating. A refractory concrete layer cannot be fastened onto the ceramic cap disclosed in prior art for use with a headless screw. However, a coupling connection is possible onto the undercut on the expansion tie. An expansion tie made from ceramic shows good insulation characteristics and is easy to manufacture.

The object of the present invention also discloses a securing system comprising ceramic assembly clips with geometries on the side that is opposite the side used for securing which are suitable for holding a concrete layer and which is shaped as, for example, claws or something similar and for fastening purposes can be clipped into a corresponding recess on the steel sheet cladding structure. The advantage of this variant compared to the ceramic expansion ties on a metallic pin is that it is completely made from ceramic and thus show better thermal insulation capabilities.

The securing system in accordance with the invention not only penetrates the thermal insulating material but also the gas-vapor mixture barrier. In accordance with an embodiment of the present invention, seals are fitted to the openings of the ceramic expansion ties or the ceramic assembly clips in the gas-vapor mixture barrier so that the hot gas cannot penetrate the openings.

Technical installations such as a hot blast valve are also fitted with interior moveable parts such as the water-cooled valve disc fitted with circumferential impermeable surfaces on the front. Such cooled parts can, on the one hand, be treated to attain refractory characteristics as described above and, on the other hand, be fitted with a gas-vapor mixture barrier and furthermore, with thermal insulation. This is not only the case for the barrier surfaces but for the entire installation except for the actually metallic impermeable surfaces.

A technical installation comprising a barrier element preferably in the shape of a valve which is cooled by a liquid and which is fitted with pipes for inflow and outflow of cooling liquid whereby both pipes are fitted in a pipe-in-pipe structure and whereby thermal insulation is fitted between the pipes. The design of the thermal insulation depends on the below described operation situations:
open hot blast valve: the water pipes are fitted on the exterior of the valve housing and are subject to free convection with the ambient air temperature,
closed position: both water pipes are fitted inside the housing and are subject to the temperature influences of the hot gas-vapor mixtures.

In accordance with an embodiment of the present invention, the technical installation has an interior room in which the moveable barrier element is fitted and has an opening for inflow and outflow of the cooling liquid and bellows are fitted to the opening for the pipe-in-pipe structure. In this manner the support structure for the opening of the pipe-in-pipe structure is sealed from the surroundings.

### BRIEF DESCRIPTION OF THE DRAWINGS

Below, the invention will be described in further detail by means of the drawings which show:

FIG. 1 perpendicular to flow direction, a sectional view of a barrier device;

FIG. 2 parallel to flow direction, a sectional view of the barrier device from FIG. 1;

FIG. 3 a sectional view of a part of the interior lining fitted with a gas-vapor mixture barrier between a refractory layer and a thermal insulating layer;

FIG. 4 a sectional view of an embodiment with a gas-vapor mixture barrier that is integrated into the refractory lining;

FIG. 5 a sectional view of an embodiment with a gas-vapor mixture barrier that is integrated into a multi-layered thermal insulation;

FIG. 6 a sectional view of an embodiment with a gas-vapor mixture barrier that is a vacuum sleeve;

FIG. 7 a sectional view of an embodiment with a pipe-in-pipe structure that is fitted with thermal insulation between the exterior and the interior pipe;

FIG. 8 a sectional view of an embodiment with a pipe-in-pipe structure that is fitted with thermal insulation between an exterior and a middle pipe as well as an inflow and outflow between a middle pipe and an interior pipe; and

FIG. 9 a sectional view of a barrier device, inflow and outflow pipes, a hood as well as glands.

### DETAILED DESCRIPTION OF THE INVENTION

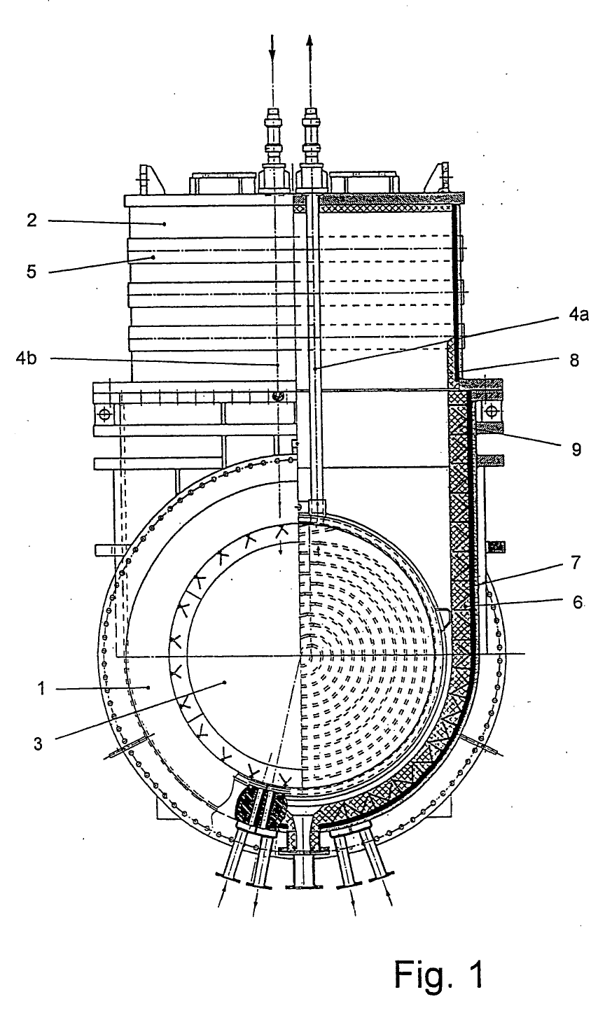

FIG. 1 shows a sectional view, perpendicular to flow direction, of a barrier device that is a hot blast valve. The valve housing 1 is fitted with a flange-mounted hood 2 into which can be slid a valve plate 3 that is shaped like a barrier device. This valve plate 3 is hollow and is fitted with spiral-shaped cooling agent channels through which a cooling agent runs. The valve plate 3 hangs on two connecting rods 4a, 4b which are hollow and at the same time function as inflow 4b and outflow 4a for the cooling agent. The connecting rods 4a and 4b run through a flange-mounted hood 2 which is fitted onto the upper side of the housing 1 and which is shaped in such a way that it can receive the valve plate 3 when the barrier device is in the open position. On the upper side of the hood 2 there are openings for the connecting rods 4a and 4b. Gland seals on the openings separate the interior space of the hot blast valve from the surroundings. Not shown here is the adjustment mechanism for both connecting rods 4a and 4b. The hood 2 comprises exterior reinforcement ribs 5, the number of which has been reduced to the number necessary for stress resistance. The interior surfaces of the device that come into contact with hot gas are fitted with a refractory coating 6. The surfaces that lie directly in the hot gas flow, in other words, the valve plate 3 and the interior wall of the housing 1, are fitted with a sufficiently thick layer made from an impermeable, particularly mechanically stable refractory concrete 6. This layer 6 is fitted onto the support structure by means of expansion ties 9. In the shown variant a highly thermal insulating layer 7 is fitted between the refractory concrete layer 6 and the supporting metal structure. The interior surfaces of the hood 2 and other surfaces that do not come into direct contact with the hot gas are fitted with a lightweight refractory concrete 8. The gas-vapor mixture barrier is integrated either into the refractory layer 6 or into the thermal insulating layer 7 or between the two layers.

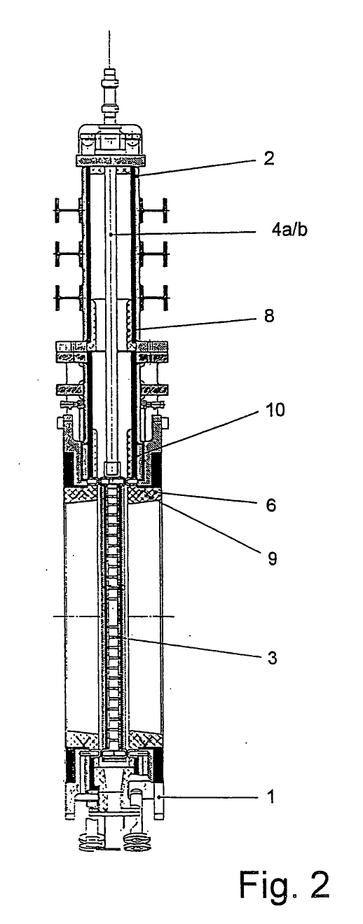

FIG. 2 shows, parallel to flow direction, a sectional view of the barrier device from FIG. 1. The gas-vapor mixture barrier 10 is fitted between the metal structure of the housing 1 and the refractory layer 6 and is a relatively thin layer compared to the refractory layer 6.

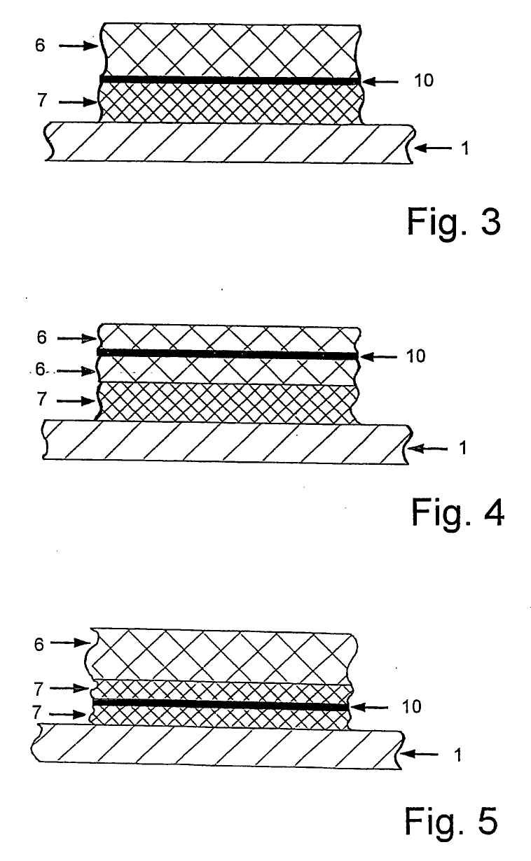

FIG. 3 shows a sectional view of a part of the interior lining through the valve housing 1 and through the interior layers, namely the thermal insulating layer 7 and the refractory layer 6. In this embodiment, the gas-vapor mixture barrier 10 is made from sheet iron or a metallic foil and is fitted between the thermal insulating layer 7 and the refractory layer 6.

FIG. 4 shows a sectional view similar to the view in FIG. 3 of an embodiment comprising a gas-vapor mixture barrier 10 that is integrated into the lining 6 in a multi-layered refractory lining 6 structure.

FIG. 5 shows a sectional view similar to the view in FIG. 3 of an embodiment with a gas-vapor mixture barrier 10 that is integrated into a multi-layered thermal insulation structure 7. The gas-vapor mixture barrier 10 can be made from a synthetic material that is reinforced with fiberglass or carbon fibers.

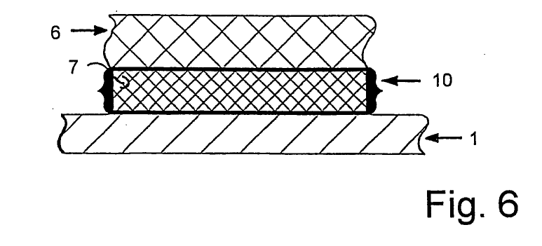

FIG. 6 shows a sectional view similar to the view in FIG. 3 of an embodiment with a gas-vapor mixture barrier 10 that is a vacuum sleeve that is made from a metallic or non-metallic material or from a combination of those materials. The vacuum sleeve surrounds thermal insulating material 7.

Preferably, the material used for the thermal insulation is a powder filament mixture pressed into boards such as AL203+SI02.

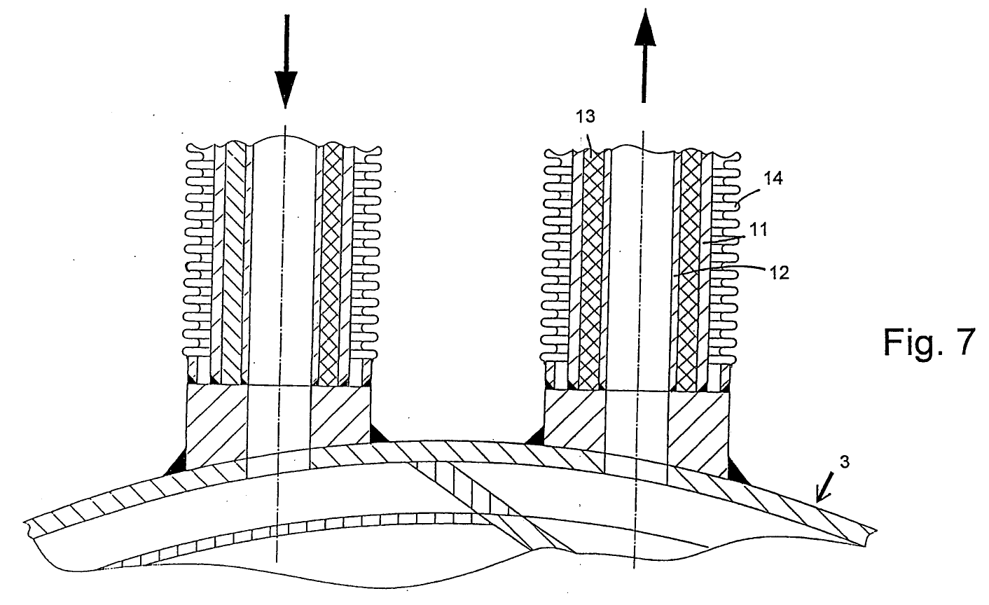

FIG. 7 shows a sectional view of a pipe-in-pipe structure that is fitted with thermal insulation 13 between an exterior pipe 11 and an interior pipe 12. The inflow and outflow of the valve plate 3 cooling agent occurs through the interior pipe 12. A bellow 14 is fitted to the exterior pipe 11 of the pipe-in-pipe structure to seal the opening in the hood 2 which is not shown.

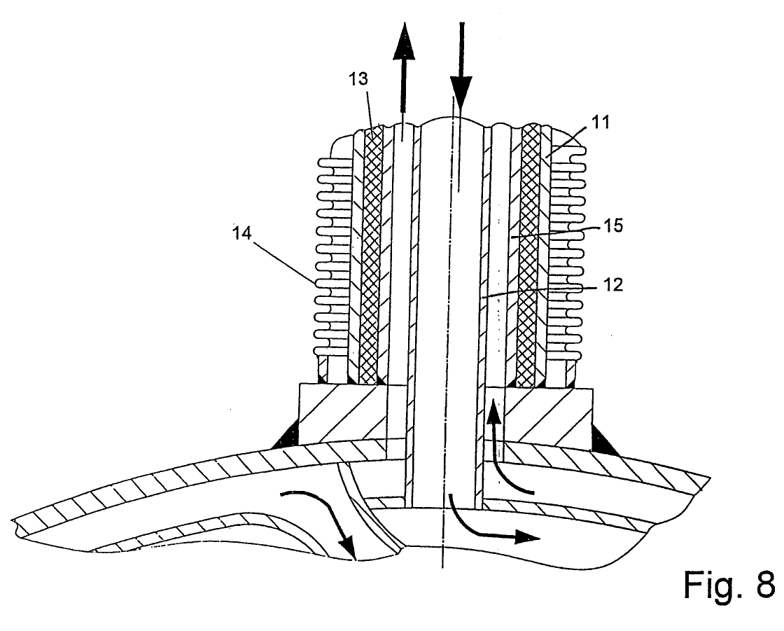

FIG. 8 shows a sectional view of another embodiment with pipes for inflow and outflow of the cooling agent and the barrier device 3. In this pipe-in-pipe structure the thermal insulation 13 is fitted between an exterior pipe 11 and a middle pipe 15 and an inflow and outflow pipe for the cooling medium is fitted between the middle pipe 15 and the interior pipe 12 and inside the interior pipe 12 a matching inflow and outflow. A bellow 14 is fitted onto the exterior pipe 11.

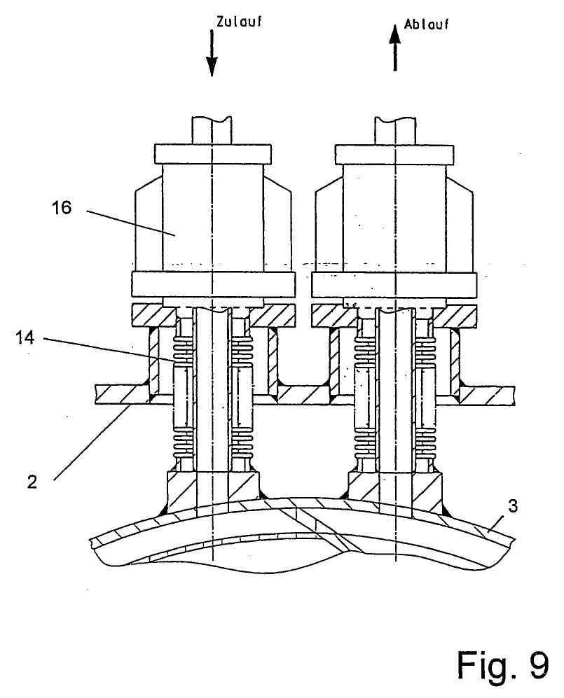

FIG. 9 shows a sectional view of a barrier device 3, the inflow and outflow pipes, a hood 2 as well as glands 16. The bellow 14 and the gland 16 together seal the interior of the hood at the opening for the cooling agent inflow and outflow from the surroundings.

In summary, the invention discloses a supporting structure for a technical installation made from a material that is not resistant to corrosion and whose inner wall at least temporarily contains a corrosive and abrasive gas-vapor mixture and which is protected from acid corrosion by a gas-vapor mixture barrier which forms a mechanical protection from the permeation of the gas-vapor mixture though the thermal insulation up to the inner wall of the supporting structure.

What is claimed is:

1. A barrier device for use as a barrier for hot gas pipes that lead from blast furnace stoves to a blast furnace, the barrier device having a support structure comprising:
a housing (1) within which a moveable barrier element (3) is fitted and is cooled by a cooling medium,
wherein all surfaces that come into contact with the hot gas are partially coated with a refractory coating (6), and wherein a gas-vapor mixture barrier (10) is fitted on the interior of the support structure.

2. A barrier device in accordance with claim 1, wherein the gas-vapor mixture barrier (10) is fitted between the refractory coating (6) and a thermal insulation layer (7).

3. A barrier device in accordance with claim 1, wherein the refractory coating is made from a material selected from the group consisting of: refractory concrete, lightweight refractory concrete, refractory stones, thermally insulating boards with a vermiculite surface suitable for the furnace, or combinations thereof.

4. A barrier device in accordance with claim 1, wherein the gas-vapor mixture barrier (10) is integrated into the refractory coating (6) in a multi-layered structure.

5. A barrier device in accordance with claim 1, further comprising a thermal insulation layer, wherein the thermal insulation layer is made from powder filament mixtures pressed into solid panels, blocks, or glass fabric and has a thermal conductivity of less than about 0.016 W/m-K for a temperature range of between 100° C. and 500° C.

6. A barrier device in accordance with claim 5, wherein the thermal insulation layer has a thermal conductivity of less than about 0.01 W/m-K for a temperature range of between 100° C. and 500° C.

7. A barrier device in accordance with claim 5, wherein the filament is vacuum evacuated.

8. A barrier device in accordance with claim 1, wherein the gas-vapor mixture barrier (10) is made from a high-temperature corrosion resistant metal.

9. A barrier device in accordance with claim 1, wherein the gas-vapor mixture barrier (10) is made from a non-metal that is corrosion resistant at a minimum temperature of 200° C.

10. A barrier device in accordance with claim 1, wherein the gas-vapor mixture barrier (10) is made from a vacuum sleeve.

11. A barrier device in accordance with claim 1, further comprising a thermal insulation layer, wherein the gas-vapor mixture barrier (10) is integrated into the thermal insulation layer in a multi-layered structure.
